(19) United States
(12) Patent Application Publication
(10) Pub. No.: US 2006/0065469 A1
(43) Pub. Date: Mar. 30, 2006

(54) Feedback assembly for an electronically controlled electro-mechanical actuating unit for a motor vehicle

(75) Inventors: Enrico Di Stefano, Cascine Vica (IT); Mario Rossi, Rivoli (IT)

Correspondence Address: MERCHANT & GOULD PC, P.O. BOX 2903, MINNEAPOLIS, MN, 55402-0903, US

(73) Assignee: Aktiebolaget skf, Goteborg (SE)

(21) Appl. No.: 10/530,555

(22) PCT Filed: Oct. 6, 2003
(86) PCT No.: PCT/EP03/11008

§ 371 Date: Apr. 7, 2005

(30) Foreign Application Priority Data
Oct. 9, 2002 (IT) T02002A000871

(51) Int. Cl. B60K 26/00

(52) U.S. Cl. 180/333

(57) ABSTRACT

A feedback assembly (1) for an electronically controlled electro-mechanical actuating unit (2) for a motor vehicle, the feedback assembly (1) having a connection to the actuating unit (2), a shaft (10), which is angularly fixed to a steering member of the motor vehicle, and an electrical actuator (20), which is angularly coupled to the shaft (10) for exerting a resistant torque on the shaft (10) itself according to the conditions of movement of the motor vehicle; a mechanical transmission (21) with concurrent axes (A, B) being set between the electrical actuator (20) and the shaft (10).

The present invention relates to a feedback assembly for an electronically controlled electro-mechanical actuating unit for a motor vehicle, i.e., for a unit commonly referred to, in the technical literature regarding the automotive sector, as “steer-by-wire” unit, a term to which reference will be made hereinafter without any further specifications.

The most recent studies and developments in the automotive field have been leading in the direction of a progressive replacement of the costly mechanico-hydraulic components with the less costly and more versatile aforementioned drive-by-wire units, and, in the case in point, have lead to replacement of the conventional steering box with a steer-by-wire unit, which is set between the steering wheel and the wheels that steer the motor vehicle (i.e., the direction wheels), and is designed to transfer each steering action onto the steering wheel in a corresponding action of steering on the direction wheels.

In effect, however, in the presence of a conventional steering box, every steering action exerted on the steering wheel is normally affected by the conditions of movement of the motor vehicle, such as, for example, the speed of the motor vehicle itself, the possible irregularities and conditions of adherence of the road surface, or the amplitude of the steering angle. These conditions of movement are transferred by the direction wheels to the steering wheel precisely via a kinematic chain made up of the mechanical members of the steering assembly, thus giving the so-called sensation of steering of the vehicle, and on the steering wheel itself take the form of torques or reactions that resist the steering action.

Consequently, in the presence of a steer-by-wire unit and in order to reproduce on the steering wheel the conditions of movement of the motor vehicle detected by the steer-by-wire unit itself, there are known feedback assemblies that are connected at input to the steer-by-wire unit and comprise, in general, a shaft that is angularly fixed to a steering member of the motor vehicle, and an electrical actuator axially coupled to the shaft for exerting a resistant torque on the shaft itself according to the conditions of movement of the motor vehicle.

The purpose of the present invention is to provide a feedback assembly for an electronically controlled electro-mechanical actuating unit for a motor vehicle, which will enable a reduction in the overall dimensions with respect to the feedback assemblies of a known type described above, and will also enable an increase in performance as compared to the known feedback assemblies.

According to the present invention there is provided a feedback assembly for an electronically controlled electro-mechanical actuating unit for a motor vehicle, the feedback assembly comprising a connection to the actuating unit, a shaft that is angularly fixed to a steering member of the motor vehicle, and an electrical actuator angularly coupled to the shaft for exerting a resistant torque on the shaft itself according to the conditions of movement of the motor vehicle; the feedback assembly being characterized in that it comprises a first mechanical transmission with concurrent axes set between the electrical actuator and the shaft.

The invention will now be described with reference to the annexed drawings, which illustrate a non-limiting example of embodiment thereof, and in which:

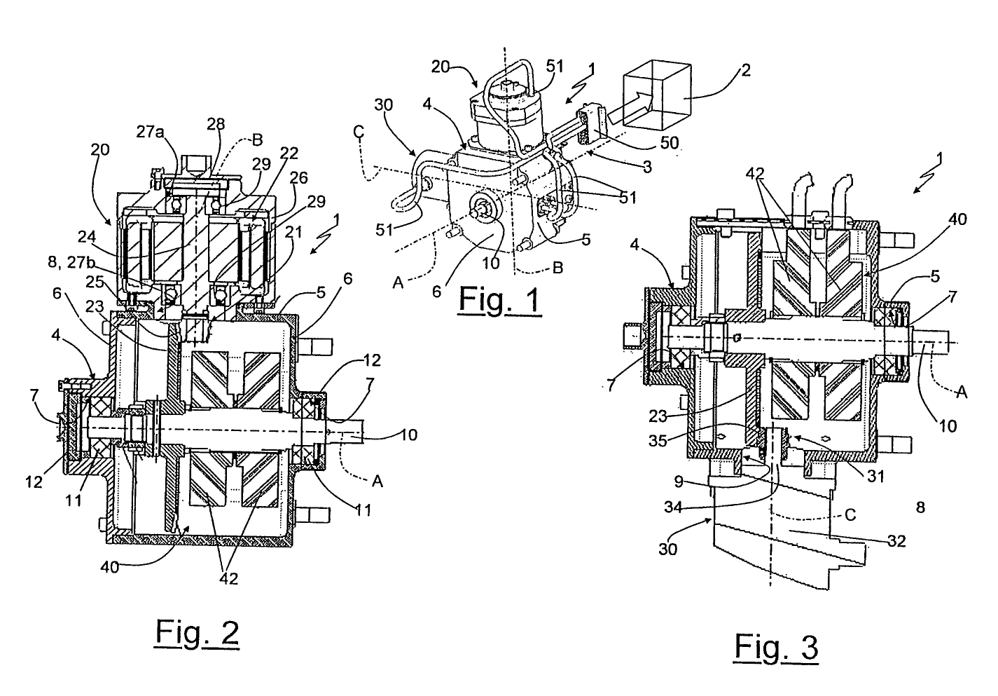

FIG. 1 is a perspective view at a reduced scale of a feedback assembly for an electronically controlled electro-mechanical actuating unit for a motor vehicle according to the present invention;

FIG. 2 is a cross-sectional view of the feedback assembly illustrated in FIG. 1 according to a first plane passing through a principal axis of the feedback assembly; and

FIG. 3 is a cross-sectional view according to a second plane, which passes through a principal axis of the feedback assembly and is orthogonal to the plane of FIG. 2.

With reference to FIG. 1, the reference number 1 designates, as a whole, a feedback assembly for an electronically controlled electro-mechanical actuating unit 2 for a motor vehicle (of a known type and not illustrated).

The assembly 1 comprises a connection 3 to the unit 2, and a containment shell or casing 4, which has a side wall 5 extending along a principal axis A of the assembly 1, and two side walls 6 arranged in a direction transverse to the axis A and on opposite sides of the wall 5.

According to what is illustrated in greater detail in FIGS. 2 and 3, the assembly 1 further comprises two openings 7 made through the walls 6 in a position corresponding to the axis A, and two further through openings 8 and 9 made through the wall 5 in positions angularly staggered with respect to one another about the axis A itself by an angle of 90°.

In particular, the openings 8 and 9 identify two secondary axes B and C, respectively, which are concurrent with one another and with the axis A, and form with one another and with the axis A itself respective right angles.

The assembly 1 further comprises a shaft 10, which is angularly fixed to a steering wheel (known and not illustrated) of the motor vehicle, and is mounted with opposite ends thereof set through the openings 7 so as to rotate about the axis A. In particular, rotation of the shaft 10 about the axis A is enabled by a pair of bearings 11, which are set in a position corresponding to the openings 7 in a position intermediate between the shaft 10 and the walls 6, and the pre-loading of which is regulated by respective threaded covers or lids 12 set substantially as closing elements for the openings 7 themselves.

The assembly 1 further comprises an electrical actuating device 20 angularly coupled to the shaft for exerting a resistant torque on the shaft 10 itself according to the conditions of movement of the motor vehicle detected by the unit 2, and two devices 30 and 40 for measuring an angular position of the shaft 10.

The devices 20 and 30 are arranged respectively along the axes B and C and are angularly coupled to the shaft 10 by means of respective mechanical transmissions 21 and 31, which comprise, in common, a ring bevel gear 23 fitted on the shaft 10 in a position corresponding to a plane basically defined by the axes B and C, and each of which comprises a respective shaft 24 and 34 set along the axis B and axis C, respectively, and a respective pinion 25 and 35 angularly fixed to the corresponding shaft 24 and 34 and arranged through the corresponding window 8 and 9 for meshing with the ring bevel gear 23. Each bevel-gear pair 23-25 and 23-35 functions as an overgear between the shaft 10 and the corresponding shaft 24 and 34 and has a respective transmission ratio of a pre-set value.

The electrical actuating device 20 is mounted on the outside of the shell 4 in a position corresponding to the window 8, and comprises a substantially cylindrical external body 26 provided, at its opposite ends and in a position corresponding to the axis B, with two openings 27a and 27b engaged by the shaft 24, the window 27b of which substantially mates with the window 8, whilst the window 27a is provided with a respective threaded lid 28 for adjustment of pre-loading of two bearings 29 set between the shaft 24 and the openings 27a and 27b themselves.

Finally, the device 20 comprises an electric brushless motor 22 set within the body 26 between the two bearings 29, and angularly fixed to the shaft 24 for exerting on the shaft 24 itself a torque, the value of which depends upon the conditions of movement of the motor vehicle and which is transmitted to the shaft 10 via the mechanical transmission 21.

The measurement device 30 is a relative-measurement device and comprises an incremental encoder 32 provided with a given angular resolution, which is incremented by a multiplying factor equal to a gear meshing ratio of the mechanical transmission 31. The encoder 32 is mounted on the outside of the wall 5 in a position corresponding to the window 9, and is angularly fixed to the shaft 34 for transmitting to the unit 1 a relative angular position of said steering wheel.

The measurement device 40 is, instead, an absolute-measurement device, and comprises two analogical position sensors 42 fitted on the shaft 10 inside the shell 4, which are designed to send to the unit 2 the absolute angular position of the aforesaid steering wheel, and each of which has a double resistive track (not illustrated) for local diagnosis of the sensors 42 themselves.

A sensor 42 is redundant with respect to the other sensor 42 in such a way as to enable a cross check between the unit 2 and the sensors 42 themselves.

The connection 3 is a connection of an electrical type, and comprises a terminal 50 for connection to the unit 2, and at least four cables 51 for connection between the terminal 50 and the devices 20, 30, and 40.

From the above description, it emerges that the arrangement with concurrent axes of the various devices which make up the assembly 1 enables extreme compactness in the axial direction to be conferred on the assembly 1 itself. In addition, by exploiting an optimal way the sizing of the transmission ratios in an optimal way, it is possible both to increase the angular resolution of the encoder 32 and to multiply the torque transmitted by the transmission 21. Finally, the simultaneous presence of the encoder 32 and the sensors 42 enables the unit 2 to carry out a further check on the coherence, using both the relative information of the device 30 and the absolute information of the device 40.

It is understood that the invention is not limited to the embodiment described and illustrated herein, which is to be considered merely as an example of embodiment of the feedback assembly for an electronically controlled electro-mechanical actuating unit for a motor vehicle, which is instead subject to further modifications regarding shapes and arrangement of parts, and details of construction and assembly.

1. A feedback assembly (1) for an electronically controlled electro-mechanical actuating unit (2) for a motor vehicle, the feedback assembly (1) comprising a connection (3) to the actuating unit (2), a shaft (10), which is angularly fixed to a steering member of the motor vehicle, and an electrical actuator (20), which is angularly coupled to the shaft (10) for exerting a resistant torque on the shaft (10) itself according to the conditions of movement of the motor vehicle; the feedback assembly (1) being characterized in that it comprises a first mechanical transmission (21) with concurrent axes (A, B), which is set between the electrical actuator (20) and the shaft (10).

2. The feedback assembly according to claim 1, wherein it comprises a relative-measurement device (30) of an angular position of the shaft (10), and a second mechanical transmission (31) with concurrent axes (A, C), which is set between the relative-measurement device (30) and the shaft (10) itself.

3. The feedback assembly according to claim 2, wherein the electrical actuator (20) and the relative-measurement device (30) are arranged according to respective axes (B, C) orthogonal to one another.

4. The feedback assembly according to claim 3, wherein each of the mechanical transmissions (21,31) comprises a respective bevel-gear pair, which functions as an overgear and is defined by a pinion (25,35) for each mechanical transmission (21,31) and a ring bevel gear (23) angularly fixed to both of the pinions (25,35) and to said shaft (10).

5. The feedback assembly according to claim 4, wherein the relative-measurement device (30) is defined by an incremental encoder (32) having a given angular resolution incremented by a multiplying factor equal to a gear meshing ratio of the respective mechanical transmission (31).

6. The feedback assembly according to claim 1, wherein it comprises an absolute-measurement device (40) of an angular position of the shaft (10), which in turn comprises at least one analogical position sensor (42) fitted on the shaft (10).

7. The feedback assembly according to claim 6, wherein the absolute-measurement device (40) comprises two analogical position sensors (42) fitted on the shaft (10), one analogical sensor (42) being redundant with respect to the other analogical sensor (42).

8. The feedback assembly according to claim 7, wherein it comprises a containment shell provided with a window for each mechanical transmission (21,31), and a threaded lid for adjustment of pre-loading of the bearings of the mechanical transmission (21,31) itself.

9. A feedback assembly for an electronically controlled electro-mechanical actuating unit for a motor vehicle, basically as described herein with reference to the annexed drawings.
